(19) United States
(12) Patent Application Publication
(10) Pub. No.: US 2012/0273470 A1
(43) Pub. Date: Nov. 1, 2012

(54) METHOD OF PROTECTING HIGH POWER LASER DRILLING, WORKOVER AND COMPLETION SYSTEMS FROM CARBON GETTERING DEPOSITS

(76) Inventors: Mark S. Zediker, Castle Rock, CO (US); Brian O. Faircloth, Evergreen, CO (US)

(21) Appl. No.: 13/403,741

(22) Filed: Feb. 23, 2012

Related U.S. Application Data
(60) Provisional application No. 61/446,312, filed on Feb. 24, 2011.
(60) Provisional application No. 61/446,041, filed on Feb. 24, 2011.
(60) Provisional application No. 61/446,412, filed on Feb. 24, 2011.
(60) Provisional application No. 61/446,407, filed on Feb. 24, 2011.

(51) Int. Cl. B23K 26/00

(52) U.S. Cl. 219/121.61

(57) ABSTRACT

There is provided a high power laser system for performing high power laser operations and methods and systems for protecting optics and components of high power laser systems while performing laser operations from damage from carbon gettering migration.

This application: (i) claims, under 35 U.S.C. §119(e)(1) the benefit of the filing date of Feb. 24, 2011 of provisional application Ser. No. 61/446,312; (ii) claims, under 35 U.S.C. §119(e)(1) the benefit of the filing date of Feb. 24, 2011 of provisional application Ser. No. 61/446,041; (iii) claims, under 35 U.S.C. §119(e)(1) the benefit of the filing date of Feb. 24, 2011 of provisional application Ser. No. 61/446,412; (iv) claims, under 35 U.S.C. §119(e)(1) the benefit of the filing date of Feb. 24, 2011 of provisional application Ser. No. 61/446,407, the entire disclosures of each of which are incorporated herein by reference.

This invention was made with Government support under Award DE-AR0000044 awarded by the Office of ARPA-E U.S. Department of Energy. The Government has certain rights in this invention.

### BACKGROUND OF THE INVENTION

### Field of the Invention

The present inventions relate to high power laser energy tools, methods and systems.

As used herein, unless specified otherwise “high power laser energy” means a laser beam having at least about 1 kW (kilowatt) of power. As used herein, unless specified otherwise “great distances” means at least about 500 m (meter). As used herein the term “substantial loss of power,” “substantial power loss” and similar such phrases, mean a loss of power of more than about 3.0 dB/km (decibel/kilometer) for a selected wavelength. As used herein the term “substantial power transmission” means at least about 50% transmittance.

As used herein, unless specified otherwise, the term “earth” should be given its broadest possible meaning, and includes, the ground, all natural materials, such as rocks, and artificial materials, such as concrete, that are or may be found in the ground, including without limitation rock layer formations, such as, granite, basalt, sandstone, dolomite, sand, salt, limestone, rhyolite, quartzite and shale rock.

As used herein, unless specified otherwise, the term “borehole” should be given it broadest possible meaning and includes any opening that is created in a material, a work piece, a surface, the earth, a structure (e.g., building, protected military installation, nuclear plant, offshore platform, or ship), or in a structure in the ground, (e.g., foundation, roadway, airstrip, cave or subterranean structure) that is substantially longer than it is wide, such as a well, a well bore, a well hole, a micro hole, slimhole, a perforation and other terms commonly used or known in the arts to define these types of narrow long passages. Wells would further include exploratory, production, abandoned, reentered, reworked, and injection wells. Although boreholes are generally oriented substantially vertically, they may also be oriented on an angle from vertical, to and including horizontal. Thus, using a vertical line, based upon a level as a reference point, a borehole can have orientations ranging from 0° i.e., vertical, to 90°,i.e., horizontal and greater than 90° e.g., such as a heel and toe and combinations of these such as for example “U” and “Y” shapes. Boreholes may further have segments or sections that have different orientations, they may have straight sections and arcuate sections and combinations thereof; and for example may be of the shapes commonly found when directional drilling is employed. Thus, as used herein unless expressly provided otherwise, the “bottom” of a borehole, the “bottom surface” of the borehole and similar terms refer to the end of the borehole, i.e., that portion of the borehole furthest along the path of the borehole from the borehole's opening, the surface of the earth, or the borehole's beginning. The terms “side” and “wall” of a borehole should to be given their broadest possible meaning and include the longitudinal surfaces of the borehole, whether or not casing or a liner is present, as such, these terms would include the sides of an open borehole or the sides of the casing that has been positioned within a borehole. Boreholes may be made up of a single passage, multiple passages, connected passages and combinations thereof, in a situation where multiple boreholes are connected or interconnected each borehole would have a borehole bottom. Boreholes may be formed in the sea floor, under bodies of water, on land, in ice formations, or in other locations and settings.

Boreholes are generally formed and advanced by using mechanical drilling equipment having a rotating drilling tool, e.g., a bit. For example and in general, when creating a borehole in the earth, a drilling bit is extending to and into the earth and rotated to create a hole in the earth. In general, to perform the drilling operation the bit must be forced against the material to be removed with a sufficient force to exceed the shear strength, compressive strength or combinations thereof, of that material. Thus, in conventional drilling activity mechanical forces exceeding these strengths of the rock or earth must be applied. The material that is cut from the earth is generally known as cuttings, e.g., waste, which may be chips of rock, dust, rock fibers and other types of materials and structures that may be created by the bit's interactions with the earth. These cuttings are typically removed from the borehole by the use of fluids, which fluids can be liquids, foams or gases, or other materials know to the art.

As used herein, unless specified otherwise, the term “advancing” a borehole should be given its broadest possible meaning and includes increasing the length of the borehole. Thus, by advancing a borehole, provided the orientation is not horizontal, e.g., less than 90° the depth of the borehole may also be increased. The true vertical depth (“TVD”) of a borehole is the distance from the top or surface of the borehole to the depth at which the bottom of the borehole is located, measured along a straight vertical line. The measured depth (“MD”) of a borehole is the distance as measured along the actual path of the borehole from the top or surface to the bottom. As used herein unless specified otherwise the term depth of a borehole will refer to MD. In general, a point of reference may be used for the top of the borehole, such as the rotary table, drill floor, well head or initial opening or surface of the structure in which the borehole is placed.

As used herein, unless specified otherwise, the terms “ream”, “reaming”, a borehole, or similar such terms, should be given their broadest possible meaning and includes any activity performed on the sides of a borehole, such as, e.g., smoothing, increasing the diameter of the borehole, removing materials from the sides of the borehole, such as e.g., waxes or filter cakes, and under-reaming.

As used herein, unless specified otherwise, the terms “drill bit”, “bit”, “drilling bit” or similar such terms, should be given their broadest possible meaning and include all tools designed or intended to create a borehole in an object, a material, a work piece, a surface, the earth or a structure including structures within the earth, and would include bits used in the oil, gas and geothermal arts, such as fixed cutter and roller cone bits, as well as, other types of bits, such as, rotary shoe, drag-type, fishtail, adamantine, single and multi-toothed, cone, reaming cone, reaming, self-cleaning, disc, three-cone, rolling cutter, crossroller, jet, core, impreg and hammer bits, and combinations and variations of the these.

In general, in a fixed cutter bit there are no moving parts. In these bits drilling occurs when the entire bit is rotated by, for example, a rotating drill string, a mud motor, or other means to turn the bit. Fixed cutter bits have cutters that are attached to the bit. These cutters mechanically remove material, advancing the borehole as the bit is turned. The cutters in fixed cutter bits can be made from materials such as polycrystalline diamond compact (“PDC”), grit hotpressed inserts (“GHI”), and other materials known to the art or later developed by the art.

In general, a roller cone bit has one, two, three or more generally conically shaped members, e.g., the roller cones, that are connected to the bit body and which can rotate with respect to the bit. Thus, as the bit is turned, and the cones contact the bottom of a borehole, the cones rotate and in effect roll around the bottom of the borehole. In general, the cones have, for example, tungsten carbide inserts (“TCI”) or milled teeth (“MT”), which contact the bottom, or other surface, of the borehole to mechanically remove material and advance the borehole as the bit it turned. In both roller cone, fixed bits, and other types of mechanical drilling the state of the art, and the teachings and direction of the art, provide that to advance a borehole great force should be used to push the bit against the bottom of the borehole as the bit is rotated. This force is referred to as weight-on-bit (“WOB”). Typically, tens of thousands of pounds WOB are used to advance a borehole using a mechanical drilling process. Mechanical bits cut rock by applying crushing (compressive) and/or shear stresses created by rotating a cutting surface against the rock and placing a large amount of WOB. In the case of a PDC bit this action is primarily by shear stresses and in the case of roller cone bits this action is primarily by crushing (compression) and shearing stresses. For example, the WOB applied to an 8¾″ PDC bit may be up to 15,000 lbs, and the WOB applied to an 8¾″ roller cone bit may be up to 60,000 lbs. When mechanical bits are used for drilling hard and ultra-hard rock excessive WOB, rapid bit wear, and long tripping times result in an effective drilling rate that is essentially economically unviable. The effective drilling rate is based upon the total time necessary to complete the borehole and, for example, would include time spent tripping in and out of the borehole, as well as, the time for repairing or replacing damaged and worn bits.

As used herein, unless specified otherwise, the term “drill pipe” should be given its broadest possible meaning and includes all forms of pipe used for drilling activities; and refers to a single section or piece of pipe, as well as, multiple pipes or sections. As used herein, unless specified otherwise, the terms “stand of drill pipe,” “drill pipe stand,” “stand of pipe,” “stand” and similar type terms should be given their broadest possible meaning and include two, three or four sections of drill pipe that have been connected, e.g., joined together, typically by joints having threaded connections. As used herein, unless specified otherwise, the terms “drill string,” “string,” “string of drill pipe,” string of pipe” and similar type terms should be given their broadest definition and would include a stand or stands joined together for the purpose of being employed in a borehole. Thus, a drill string could include many stands and many hundreds of sections of drill pipe. As used herein, unless specified otherwise, the term “tubular” should be given its broadest possible meaning and includes drill pipe, casing, riser, coiled tube, composite tube, vacuum insulated tubing (“VIT”), production tubing and any similar structures having at least one channel therein that are, or could be used, in the drilling industry. As used herein the term “joint” should be given its broadest possible meaning and includes all types of devices, systems, methods, structures and components used to connect tubulars together, such as for example, threaded pipe joints and bolted flanges. For drill pipe joints, the joint section typically has a thicker wall than the rest of the drill pipe. As used herein the thickness of the wall of tubular is the thickness of the material between the internal diameter of the tubular and the external diameter of the tubular.

As used herein, unless specified otherwise, the terms “blowout preventer,” “BOP,” and “BOP stack” are to be given their broadest possible meaning, and include: (i) devices positioned at or near the borehole surface, e.g., the seafloor, which are used to contain or manage pressures or flows associated with a borehole; (ii) devices for containing or managing pressures or flows in a borehole that are associated with a subsea riser; (iii) devices having any number and combination of gates, valves or elastomeric packers for controlling or managing borehole pressures or flows; (iv) a subsea BOP stack, which stack could contain, for example, ram shears, pipe rams, blind rams and annular preventers; and, (v) other such similar combinations and assemblies of flow and pressure management devices to control borehole pressures, flows or both and, in particular, to control or manage emergency flow or pressure situations.

As used herein, unless specified otherwise “offshore” and “offshore drilling activities” and similar such terms are used in their broadest sense and would include drilling activities on, or in, any body of water, whether fresh or salt water, whether manmade or naturally occurring, such as for example rivers, lakes, canals, inland seas, oceans, seas, bays and gulfs, such as the Gulf of Mexico. As used herein, unless specified otherwise the term “offshore drilling rig” is to be given its broadest possible meaning and would include fixed towers, tenders, platforms, barges, jack-ups, floating platforms, drill ships, dynamically positioned drill ships, semi-submersibles and dynamically positioned semi-submersibles. As used herein, unless specified otherwise the term “seafloor” is to be given its broadest possible meaning and would include any surface of the earth that lies under, or is at the bottom of, any body of water, whether fresh or salt water, whether manmade or naturally occurring. As used herein, unless specified otherwise the terms “well” and “borehole” are to be given their broadest possible meaning and include any hole that is bored or otherwise made into the earth's surface, e.g., the seafloor or sea bed, and would further include exploratory, production, abandoned, reentered, reworked, and injection wells.

As used herein, unless specified otherwise, the terms “decommissioning,” “plugging” and “abandoning” and similar such terms should be given their broadest possible meanings and would include activities relating to the cutting and removal of casing and other tubulars from a well (above the surface of the earth, below the surface of the earth and both), modification or removal of structures, apparatus, and equipment from a site to return the site to a prescribed condition, the modification or removal of structures, apparatus, and equipment that would render such items in a prescribe inoperable condition, the modification or removal of structures, apparatus, and equipment to meet environmental, regulatory, or safety considerations present at the end of such items useful, economical or intended life cycle. Such activities would include for example the removal of onshore, e.g., land based, structures above the earth, below the earth and combinations of these, such as e.g., the removal of tubulars from within a well in preparation for plugging. The removal of offshore structures above the surface of a body of water, below the surface, and below the seafloor and combinations of these, such as fixed drilling platforms, the removal of conductors, the removal of tubulars from within a well in preparation for plugging, the removal of structures within the earth, such as a section of a conductor that is located below the seafloor and combinations of these.

As used herein, unless specified otherwise, the terms “workover,” “completion” and “workover and completion” and similar such terms should be given their broadest possible meanings and would include activities that place at or near the completion of drilling a well, activities that take place at or the near the commencement of production from the well, activities that take place on the well when the well is producing or operating well, activities that take place to reopen or reenter an abandoned or plugged well or branch of a well, and would also include for example, perforating, cementing, acidizing, fracturing, pressure testing, the removal of well debris, removal of plugs, insertion or replacement of production tubing, forming windows in casing to drill or complete lateral or branch wellbores, cutting and milling operations in general, insertion of screens, stimulating, cleaning, testing, analyzing and other such activities. These terms would further include applying heat, directed energy, preferably in the form of a high power laser beam to heat, melt, soften, activate, vaporize, disengage, desiccate and combinations and variations of these, materials in a well, or other structure, to remove, assist in their removal, cleanout, condition and combinations and variation of these, such materials.

As used herein, unless specified otherwise, the term “line structure” should be given its broadest meaning, unless specifically stated otherwise, and would include without limitation: wireline; coiled tubing; slick line; logging cable; cable structures used for completion, workover, drilling, seismic, sensing, and logging; cable structures used for subsea completion and other subsea activities; umbilicals; cables structures used for scale removal, wax removal, pipe cleaning, casing cleaning, cleaning of other tubulars; cables used for ROV control power and data transmission; lines structures made from steel, wire and composite materials, such as carbon fiber, wire and mesh; line structures used for monitoring and evaluating pipeline and boreholes; and would include without limitation such structures as Power & Data Composite Coiled Tubing (PDT-COIL) and structures such as Smart Pipe® and FLATpak®.

### SUMMARY

There is a need to address and mitigate gettering deposit formation in systems, methods and tools that utilize high power laser energy over great distances to small and/or difficult to access locations, positions or environments for activities such as monitoring, cleaning, controlling, assembling, drilling, welding, machining and cutting. Such need is present in the nuclear industry, the chemical industry, the subsea exploration, salvage and construction industry, the pipeline industry, the military, and the oil, natural gas and geothermal industries to name just a few. The present inventions, among other things, solve these and other needs by providing the articles of manufacture, devices and processes taught herein.

There is provided a method of protecting optics and components of a high power laser system while performing laser operations at a remote location from damage from carbon gettering migration, the method including: delivering a high power laser beam to a remote location by means of a high power laser system including a high power laser having at least about 20 kW of power, an optical transition device, an of optical connector, an optical cable and a high power laser tool including an optical package; propagating a laser beam having at least about 20 kW along a beam path, wherein the beam path is optically associated with the optical transition device, the optical connector, the optical cable and the high power laser tool and the optical package, whereby the laser beam is delivered to the remote location; and, providing a means for preventing carbon gettering on a component of the high power laser system; whereby, carbon deposits are prevented from covering the component of the high power laser system.

Further there are provided a methods of protecting optics and components of a high power laser system while performing laser operations at a remote location from damage from carbon gettering migration that may also include: the means for preventing gettering migration having a gas flow having less than about 20% oxygen; the means for preventing gettering migration provided to a plurality of components of the high power laser system; wherein the plurality of components include the optical transition device, the optical connector, an end of the optical cable, and the optical package of the high power laser tool; when the laser beam has a power of at least about 50 kW; and when the laser beam has a power of at least about 80 kW.

Further, there is provided a method of protecting optics and components of a high power laser system while performing laser operations at a remote location from damage from carbon gettering migration, the method including: delivering a high power laser beam to a remote location by means of a high power laser system including a high power laser having at least about 30 kW of power, an of optical connector, an optical cable having a distal and a proximal end, and a high power laser tool; propagating a laser beam having at least about 20 kW along a beam path, wherein the beam path is optically associated with the optical connector, the optical cable, the distal end of the optical cable, the proximal end of the optical cable and the high power laser tool, and wherein a fluence is present at least one point or location along the beam path that is at least about 100,000 w/cm2, and whereby the laser beam is delivered to the remote location; and, providing a means for preventing carbon gettering on a component of the high power laser system; whereby, carbon deposits are prevented from covering the component of the high power laser system.

Still further, there are provided methods of protecting optics and components of a high power laser system while performing laser operations at a remote location from damage from carbon gettering migration, by: delivering a high power laser beam to a remote location by means of a high power laser system including a high power laser having at least about 30 kW of power, an of optical connector, an optical cable having a distal and a proximal end, and a high power laser tool; propagating a laser beam having at least about 20 kW along a beam path, wherein the beam path is optically associated with the optical connector, the optical cable, the distal end of the optical cable, the proximal end of the optical cable and the high power laser tool, and wherein a fluence along the beam path is at least about 100,000 w/cm2, and whereby the laser beam is delivered to the remote location; and, providing a means for preventing carbon gettering on a component of the high power laser system; whereby, carbon deposits are prevented from covering the component of the high power laser system. This method may also have: the means for preventing including a gas flow including air; the means for preventing provided to a plurality of components of the high power laser system; wherein the plurality of components comprises: the optical connector, the distal end of the optical cable, the proximal end of the optical cable and the high power laser tool; wherein the means for preventing is provided by sealing an optical assembly with an amount of oxygen present; wherein the means for preventing is provided by purging an optical assembly with a gas including oxygen and the sealing the optical assembly; and wherein the amount of oxygen present is less than 1%.

### BRIEF DESCRIPTION OF THE DRAWINGS

FIG. 1 is a schematic view of an embodiment of a mobile high power laser system in accordance with the present invention.

FIG. 2 is a schematic view of an embodiment of a modular high power laser system in accordance with the present invention.

FIG. 3 is schematic view of an embodiment of a creel for winding and unwinding a high power laser conveyance device in accordance with the present invention.

FIG. 4 is a schematic view of an embodiment of a high power laser drilling, workover and completion unit in accordance with the present invention.

FIG. 5 is a cross sectional view of an embodiment of a high power laser conveyance device in accordance with the present invention.

FIG. 6 is a cross-sectional view of an embodiment of a high power laser conveyance device in accordance with the present invention.

FIGS. 7 to 10 are cross-sectional views of configurations of embodiments of composite high power laser conveyance devices in accordance with the present invention.

FIG. 11 is cross-sectional view of an embodiment of a tubular having a helixed high power fiber in accordance with the present invention.

FIG. 12 is a schematic view of an embodiment of a directional drilling while casings system in accordance with the present invention.

FIG. 13 is a schematic view of an embodiment of a packer dislodging system in accordance with the present invention.

### DESCRIPTION OF THE PREFERRED EMBODIMENTS

The present inventions relate to systems for delivering high power laser energy to high power laser energy tools and methods of using such systems and tools.

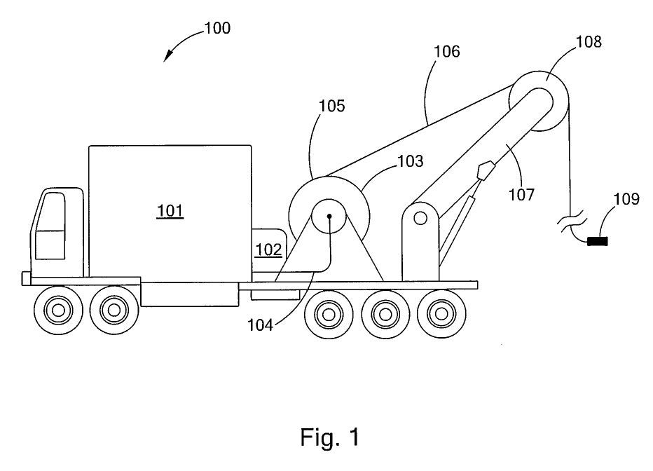

In FIG. 1 there is provided an embodiment of a mobile high power laser beam delivery system 100. A laser room 100 houses a source for providing a high power laser beam, a chiller, and a laser system controller, which is preferably capable of being integrated with a control system for a high power laser tool. A high power fiber 104 leaves the laser control room 101 and enters a rotational transition device such as an optical slip ring 103, thus optically associating the high power laser with the optical slip ring. Within the optical slip ring the laser beam is transmitted from a non-rotating optical fiber to the rotating optical fiber that is contained within the optical cable 106 that is wrapped around spool 103. The optical cable 106 is associated with cable handling device 107 that has an optical cable block 108. The optical cable block provides a radius of curvature when the optical cable is run over it such that bending losses are minimized. When determining the size of the spool, the block or other optical cable handling devices care should be taken to avoid unnecessary bending losses to the fiber. The optical cable has a connector/coupler device 109 that attaches (optically associates with) to the high power laser tool. The device 109 may also mechanically connect to the tool, a separate mechanical connection device may be used, or a combination mechanical-optical connection device may be used.

The optical cable has at least one high power optical fiber, and may have additional fibers, as well as, other conduits, cables etc. for providing and receiving material, data, instructions to and from the high power laser tool. Although this system is shown as truck mounted, it is recognized the system could be mounded on or in other mobile or moveable platforms, such as a skid, a shipping container, a boat, a work boat, a barge, a rail car, a drilling rig, a work over rig, a work over truck, a drill ship, or it could be permanently installed at a location.

The optical cable, preferably is a line structure, which may have multiple channels for transporting different materials, cables, or lines to a laser tool such as an electric motor laser bottom hole assemble, a laser cutting tool, a laser drilling tool, and a laser bottom hole assembly. Examples of such laser tools are disclose and taught in the following US patent applications and US patent application Publications: US 2010/0044106, US 2010/0044104, US 2010/0044105, Ser. No. 13/211,729, Ser. No. 13/222,931, Ser. No. 13/347,445, Ser. No. 13/366,882, Ser. No. 12/896,021 and Ser. No. 61/446,042, the entire disclosures of each of which are incorporated herein by reference. The channels may be in, on, integral with, releasably connected to, or otherwise associated with the line structure, and combinations and variations of these. Further examples of optical fibers, optical cables, connectors and conveyance structures are disclosed and taught in the following US patent applications and US patent Publications: Publication No. US 2010/0044106, Publication No. 2010/0215326, Publication No. 2012/0020631, Ser. No. 13/210,581, and Ser. No. 61/493,174, the entire disclosures of each of which are incorporated herein by reference.

In general, an optical assembly, an optical package, an optical component and an optic, that may be utilized with high power laser tools and systems, may be generally any type of optical element and/or system that is capable of handling the laser beam (e.g., transmitting, reflecting, etc. without being damaged or quickly destroyed by the beams energy), that is capable of meeting the environmental conditions of use (e.g., down hole temperatures, pressures, vibrates, etc.) and that is capable of effecting the laser beam in a predetermined manner (e.g., focus, de-focus, shape, collimate, power distribution, steer, scan, etc.). Further examples of optical assemblies, optical packages, optical components and optics are disclosed and taught in the following US patent applications and US patent application Publications: US 2010/0044105, US 2010/0044104, Ser. No. 13/222,931, Ser. No. 61/446,040, Ser. No. 61/446,312 and co-filed US patent application having attorney docket no. 13938/87 (Foro s3b-1) filed contemporaneously herewith, the entire disclosures of each of which are incorporated herein by reference.

The laser systems, tools and methods of the present invention may utilize a single high power laser, or they may have two or three high power lasers, or more. The high power laser beam, or beams, may have 10 kW, 20 kW, 40 kW, 80 kW or more power; and have a wavelength in the 800 nm to 1600 nm range. High power solid-state lasers, specifically semiconductor lasers and fiber lasers are preferred, because of durability, ruggedness, and their short start up time and essentially instant-on capabilities. The high power lasers for example may be fiber lasers or semiconductor lasers having 10 kW, 20 kW, 50 kW or more power and, which emit laser beams with wavelengths from about 1060 to about 2100 nm, for example about the 1550 nm (nanometer) ranges, or about 1070 nm ranges, or about the 1083 nm ranges or about the 1900 nm ranges (wavelengths in the range of 1900 nm may be provided by Thulium lasers). Examples of preferred lasers, and in particular solid-state lasers, such as fibers lasers, are disclosed and taught in the following US Patent Application Publications 2010/0044106, 2010/0044105, 2010/0044103, 2010/0215326 and 2012/0020631, the entire disclosure of each of which are incorporated herein by reference. By way of example, and based upon the forgoing patent applications, there is contemplated the use of a 10 kW laser, the use of a 20 kW, the use of a 40 kW laser, as a laser source to provide a laser beam having a power of from about 5 kW to about 40 kW, greater than about 8 kW, greater than about 18 kW, and greater than about 38 kW at the work location, or location where the laser processing or laser activities, are to take place. There is also contemplated, for example, the use of more than one, and for example, 4, 5, or 6, 20 kW lasers as a laser source to provide a laser beam having greater than about 40 kW, greater than about 60 kW, greater than about 70 kW, greater than about 80 kW, greater than about 90 kW and greater than about 100 kW. One laser may also be envisioned to provide these higher laser powers.

High powered optical cables, spools of cables, creels, connectors and reels of cables of the type disclosed and taught in the following US patent applications and US patent application Publications: 2010/0044104, 2010/0044103, 2010/0215326, 2012/0020631, Ser. No. 13/366,882, Ser. No. 61/493,174 and Ser. No. 13/210,581, the entire disclosures of each of which are incorporated herein by reference, may be used in conjunction with the present systems. Thus, the optical cable or the conveyance structure may be: a single high power optical fiber; it may be a single high power optical fiber that has shielding; it may be a single high power optical fiber that has multiple layers of shielding; it may have two, three or more high power optical fibers that are surrounded by a single protective layer, and each fiber may additionally have its own protective layer; it may contain other conduits such as a conduit to carry materials to assist a laser cutter, for example oxygen; it may have other optical or metal fibers for the transmission of data and control information and signals; it may be any of the combinations set forth in the foregoing patents and combinations and variations thereof.

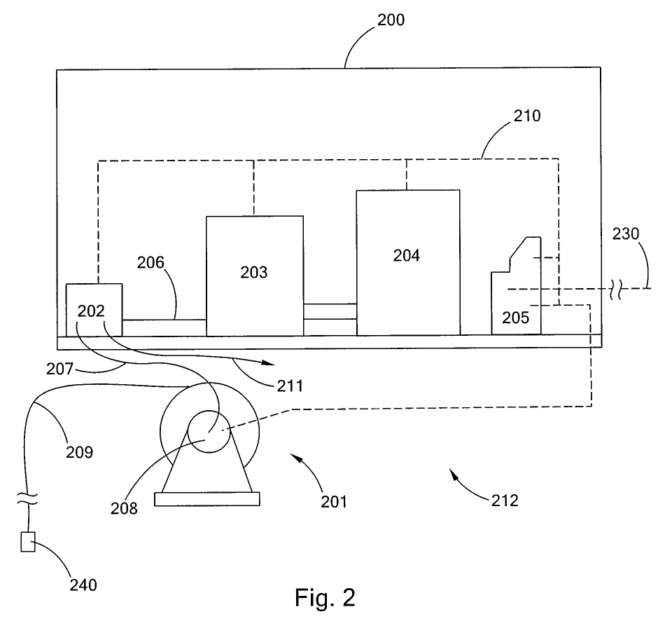

In FIG. 2 there is provided a schematic drawing of an embodiment of a laser room 200 and spool 201. In this embodiment the laser room 200 contains a high power beam switch 202, a high power laser unit 203 (which could be a number of lasers, a single laser, or laser modules, collectively having at least about 5 kW, 10 kW, 20 kW, 30 kW 40 kW, 70 kW or more power), a chiller or connection to a chiller assembly 204 for the laser unit 203 and a control counsel 205 that preferably is in control communication with a control system and network 210. Additionally multiple lasers may be combined with a high power beam combiner to launch about 40 kW, about 60 kW about 80 kW or greater down a single fiber. Preferably, the larger comments of the chiller 204, such as the heat exchanger components, will be located outside of the laser room 200, both for space, noise and heat management purposes. The high power laser unit 203 is optically connected to the beam switch 202 by high power optical fiber 206. The beam switch 202 optically connects to spool 201 by means of an optical slip ring 208, which in turn optically and rotationally connects to the optical cable 209. In higher power systems, e.g., greater than 20 kW the use of multiple fibers, multiple beam switches, and other multiple component type systems may be employed. The optical cable is then capable of being attached to a high power laser tool. A second optical cable 211, which could also be just an optical fiber, leaves the beam switch 202. This cable 211 could be used with a different spool for use with a different tool, or directly connect to a tool. Electrical power can be supplied from the location where the laser room is located, from the mobile unit that transported the laser room, from separate generators, separate mobile generators, or other sources of electricity at the work site or bought to the work site.

Preferably in a high power laser system a controller is in communication, via a network, cables fiber or other type of factory, marine or industrial data and control signal communication medium with the laser tool and potentially other systems at a work site. The controller may also be in communication with a first spool of high power laser cable, a second spool of high power laser cable and a third spool of high power laser cable, etc. Examples of such control systems and networks are disclosed and taught in the following US patent applications: Ser. No. 61/446,412, and co-filed US patent application having attorney docket no. 13938/82 (Foro s20a), the entire disclosures of each of which are incorporated herein by reference.

In a break detection and monitoring system there may also be utilized a spectrometer monitoring the back reflection signal on the fiber. Thus, in the event of a failure of an optic or the fiber the wavelength of laser light back-reflected along the fiber is greatly enhanced and can be used to detect remotely when a failure has occurred downhole. This system could have a thin foil packaged adjacent to the optical fiber to conduct an electrical signal to the bottom of the hole and the stainless steel tube encapsulating the fiber would be used as the return for the interlock signal. This system may also employ two thin foils that are packaged adjacent to the optical fiber in the metal tube and connected at the bottom of the hole to the connector switch, which indicates the connector (examples of connectors are disclosed in U.S. patent application Ser. No. 61/493,174) is seated. Additionally, a thermal switch may be included in the connector housing connected in series with the thin foils for the purpose of stopping the laser in the event of an overheat situation in the connector. The thermal switch provides additional protection to the downhole optic system preventing additional damage and propagation of damage through the umbilical or conveyance structure.

Thus, for example a spectrometer may be used to monitor a back-reflected signal from a tool at the distal end of the fiber. A controller, computer, the spectrometer or other device may then integrate the back-reflected signal over different wavelength regions to look for characteristic spectral signatures that indicate damage to optics and the fiber, or other components along the optical paths. Also, a method using a spectrometer to monitor the back reflected signal from the tool at the distal end of the fiber and monitoring the magnitude of the backreflected signal at the laser wavelength and using that to detect the onset of damage to the optics and the fiber, may be employed.

One or more high power optical fibers, as well as, lower power optical fibers may be used or contained in a single cable that connects the tool to the laser system, this connecting cable could also be referred to herein as a tether, an umbilical, wire line, or a line structure. The optical fibers may be very thin on the order of hundreds e.g., about greater than 100, of μm (microns). These high power optical fibers have the capability to transmit high power laser energy having many kW of power (e.g., 5 kW, 10 kW, 20 kW, 50 kW or more) over many thousands of feet, e.g., over 1,000 feet, over 2,000 feet, over 5,000 feet, over 10,000 feet and greater. The suppression and management of non-linear effects and other types of losses, which would otherwise prevent, prohibit, greatly reduce or hammer such long distance high power transmission over optical fibers, is disclosed an taught in the following US patent application Publications: US 2010/0044106, US 2010/0044103, US 2010/0215236, and US 2012/0020631, the entire disclosures of each of which are incorporated herein by reference. The high power optical fiber further provides the ability, in a single fiber, although multiple fibers may also be employed, to convey high power laser energy to the tool, convey control signals to the tool, and convey back from the tool control information and data (including video data). In this manner the high power optical fiber has the ability to perform, in a single very thin, less than for example 1000 μm diameter fiber, the functions of transmitting high power laser energy for activities to the tool, transmitting and receiving control information with the tool and transmitting from the tool data and other information (data could also be transmitted down the optical cable to the tool). As used herein, unless specified otherwise, the term “control information” is to be given its broadest meaning possible and would include all types of communication to and from the laser tool, system or equipment.

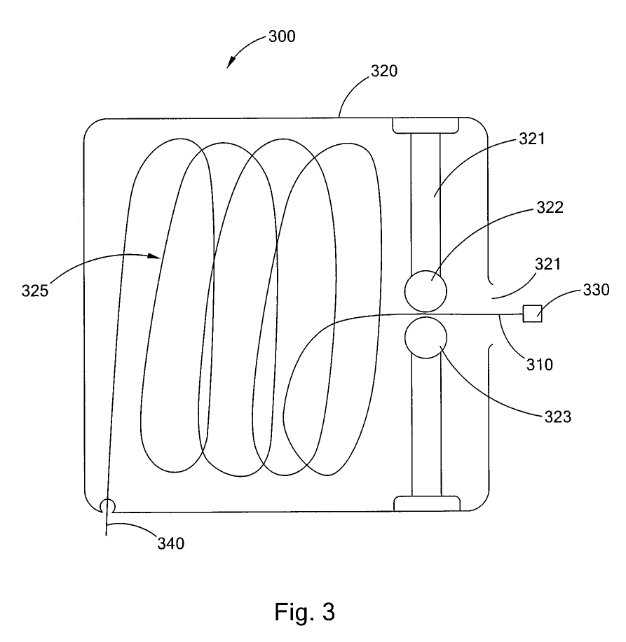

In FIG. 3 there is provided an optical cable handling device 300 having a housing 320 and an opening 321. Optical cable handling device 300 has an assembly 321 for winding and unwinding the high power optical cable 310. The assembly 321 has roller 322, 323. In this embodiment the cable is stored in a helix 325 that can be unwound and rewound as the tool is deployed and recovered. This type of device could be mounted with the laser as a modular system, an integrated system, a unified mobile system, or separate from and optically associable with a high power laser by way of proximal end 340 of cable 310.

In general, the optical cable, e.g., structure for transmitting high power laser energy from the system to a location where high power laser activity is to be performed by a high power laser tool, may, and preferably in some applications does, also serve as a conveyance device for the high power laser tool. The optical cable, e.g., conveyance device can range from a single optical fiber to a complex arrangement of fibers, support cables, shielding on other structures, depending upon such factors as the environmental conditions of use, tool requirements, tool function(s), power requirements, information and data gathering and transmitting requirements, etc.

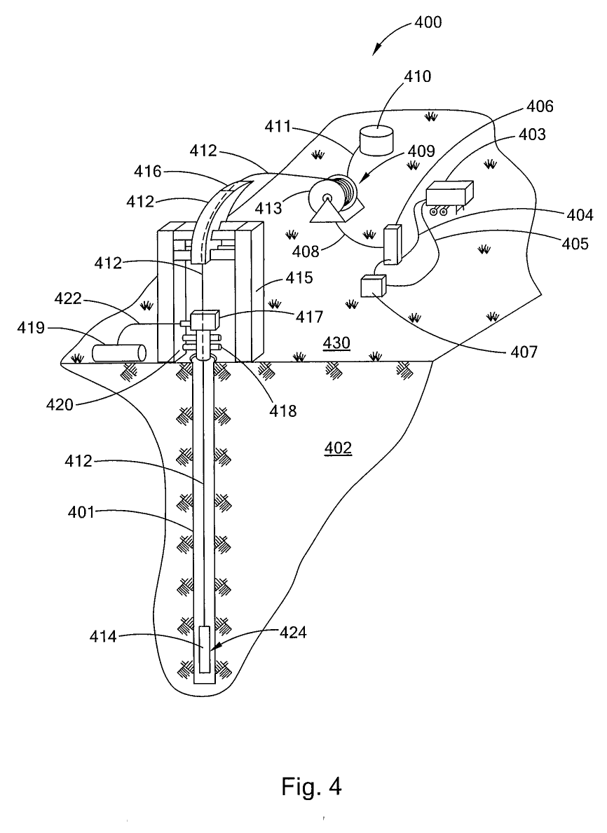

In FIG. 4 there is provided an embodiment of a high power laser drilling workover and completion system as deployed in the field for conducting drilling operations, using a LBHA, that is powered by an electric motor. A control system as disclosed and taught in the following US patent applications: Ser. No. 61/446,412, and co-filed patent application attorney docket no. 13938/82 (Foro s20a) filed contemporaneously herewith, the entire disclosures of each of which are incorporated herein by reference, may be used with this system. The control system may be expanded, or networked with other control systems, to provide an integrated control network for some, or all of the components disclosed in that deployment.

Thus, the laser drilling system 400 is shown as deployed in the field in relation to the surface of the earth 430 and a borehole 401 in the earth 402. There is also an electric power source 403, e.g. a generator, electric cables 404, 405, a laser 406, a chiller 407, a laser beam transmission means, e.g., an optical fiber, optical cable, or conveyance device 408, a spool or reel 409 (or other handing device, e.g., the FIG. 3 embodiment) for the conveyance device, a source of working fluid 410, a pipe 411 to convey the working fluid, a down hole conveyance device 412, a rotating optical transition device 413, a high power laser tool 414, a support structure 415, e.g., a derrick, mast, crane, or tower, a handler 416 for the tool and down hole conveyance device, e.g., an injector, a diverter 417, a BOP 418, a system to handle waste 419, a well head 420, a bottom 421 of the borehole 401, and a connector 422.

In addition to the injector, gravity, pressure, fluids, differential pressure, buoyancy, a movable packer arrangement, and tractors, other motive means may be used to advance the downhole tool to its location of operation, such as for example to a predetermined location in a borehole, for example, the bottom of the borehole so that it may be laser-mechanically drilled to drill and advance the borehole.

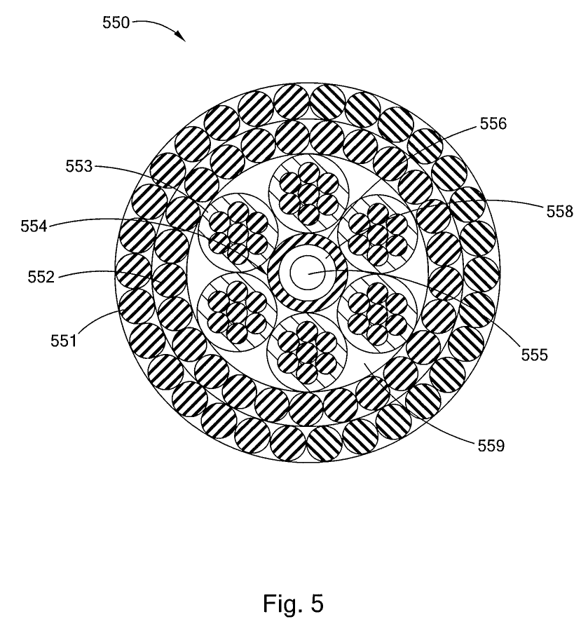

An embodiment of such an optical cable is provided in FIG. 5, which illustrates a wireline 550 having two layers of helically wound armor wires, an outer layer 551 and an inner layer 552. Other types and arrangement of wire lines are known to those of skill in the art. There is further provided a plurality of insulated electrical conductors 553 and an optical fiber configuration 554, the configuration 554 having an optical fiber 555 and an outer protective member 556. The space 558 between the outer surface of the fiber and the inner surface of the protective member, may further be filled with, or otherwise contain, a gel, an elastomer or some other material, such as a fluid. Similarly, a second space 559 may further be filled with, or otherwise contain, a gel, an elastomer or some other material, such as a fluid, which material will prevent the armor wires from crushing inwardly from external pressure of an application, such as the pressure found in a well bore. Further the fiber may be packaged in a Teflon® sleeve or equivalent type of material or sleeve.

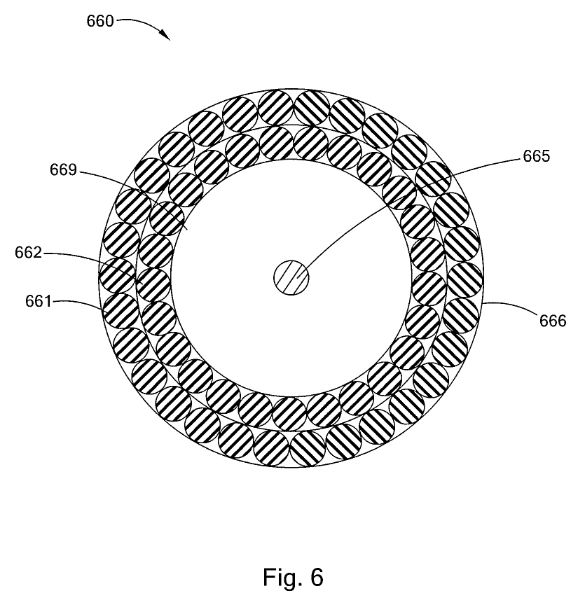

A further embodiment is provided in FIG. 6 which illustrates a wireline 660 having outer armor wire layer 661 and inner armor wire layer 662. The wireline 660 constitutes an optical fiber configuration having a fiber 665 and an outer protective member 666. The space 669 between the fiber 665 and the armor wire layer 662 may further be filled with, or otherwise contain, a gel, an elastomer or some other material, such as a fluid, which material will prevent the armor wires from crushing inwardly from external pressure of an application, such as the pressure found in a well bore.

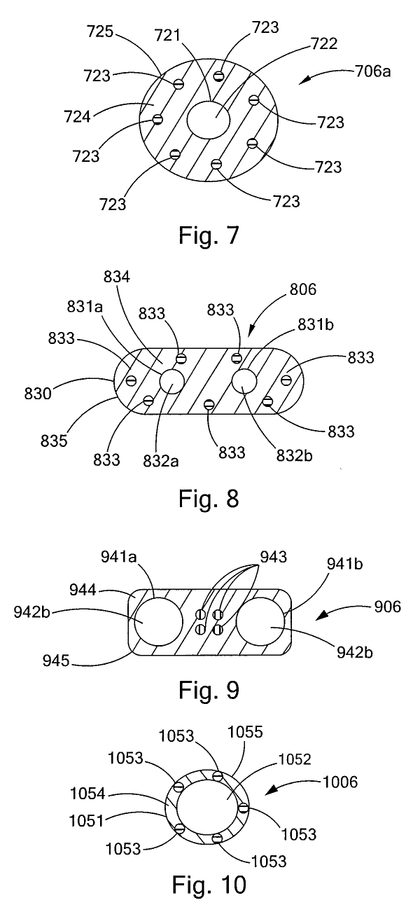

In FIG. 7 there is provided an embodiment of a conveyance device 706a, having an inner member 721, e.g., a tube, the inner member 721 having an open area or open space 722. A plurality of lines 723, e.g., electric conductors, hydraulic lines, tubes, data lines, fiber optics, fiber optics data lines, high power optical fibers, and/or high power optical fibers in a metal tube. The device 706a has an outer member 725 and in the area between the outer member 725 and the inner member 721 is filled with and/or contains a supporting or filling medium 724, e.g., an elastomer or the same or similar material that the inner member and/or outer member is made from.

In FIG. 8 there is provided a conveyance device 806, having an inner members, 831a and 831b, e.g., a tubes, the inner members 831a and 831b having an open area or open space 832a, 832b associated therewith. A plurality of lines 833, e.g., electric conductors, hydraulic lines, tubes, data lines, fiber optics, fiber optics data lines, high power optical fibers, and/or high power optical fibers in a metal tube. The device 806 has an outer member 835 and the area between the outer member 835 and the inner members 831a and 831b is filled with and/or contains a supporting medium 834, e.g., an elastomer or the same or similar material that the inner member and/or outer member is made from.

In FIG. 9 there is provided a conveyance device 906, having an inner members, 941a and 941b, e.g., a tubes, the inner members 941a and 941b having an open area or open space 942a, 942b associated therewith. A plurality of lines 943, e.g., electric conductors, hydraulic lines, tubes, data lines, fiber optics, fiber optics data lines, high power optical fibers, and/or high power optical fibers in a metal tube. The device 906 has an outer member 945 and the area between the outer member 945 and the inner members 941a and 941b is filled with and/or contains a supporting medium 944, e.g., an elastomer or the same or similar material that the inner member and/or outer member is made from.

In FIG. 10 there is provided a conveyance device 1006, having an inner member 1051, e.g., a tube, the inner member 1051 having an open area or open space 1052. A plurality of lines 1053, e.g., electric conductors, hydraulic lines, tubes, data lines, fiber optics, fiber optics data lines, high power optical fibers, and/or high power optical fibers in a metal tube. The device 1006 has an outer member 1055 and in the area between the outer member 1055 and the inner member 1051 is filled with and/or contains a supporting medium 1054, e.g., an elastomer or the same or similar material that the inner member and/or outer member is made from.

These optical cables may be very light. For example an optical fiber with a Teflon shield may weigh about ⅔ lb per 1000 ft, an optical fiber in a metal tube may weight about 2 lbs per 1000 ft, and other similar, yet more robust configurations may weigh as little as about 5 lbs or less, about 10 lbs or less, and about 100 lbs or less (per 1000 ft). Should weight not be a factor and for very harsh and/or demanding uses the optical cables could weight substantially more.

The tools that are useful with high power laser systems many generally be laser cutters, laser cleaners, laser monitors, laser welders and laser delivery assemblies that may have been adapted for a special use or uses. Configurations of optical elements for culminating and focusing the laser beam can be employed with these tools to provide the desired beam properties for a particular application or tool configuration. A further consideration, however, is the management of the optical effects of fluids or debris that may be located within the beam path between laser tool and the work surface.

It is advantageous to minimize the detrimental effects of such fluids and materials and to substantially ensure, or ensure, that such fluids do not interfere with the transmission of the laser beam, or that sufficient laser power is used to overcome any losses that may occur from transmitting the laser beam through such fluids. To this end, mechanical, pressure and jet type systems may be utilized to reduce, minimize or substantially eliminate the effect of these fluids on the laser beam.

For example, mechanical devices may be used to isolate the area where the laser operation is to be performed and the fluid removed from this area of isolation, by way of example, through the insertion of an inert gas, or an optically transmissive fluid, such as water, an oil, kerosene, or diesel fuel. The use of a fluid in this configuration has the added advantage that it is essentially incompressible.

Preferably, if an optically transmissive, or substantially transmissive fluid is employed the fluid will be flowing, and in particular flowing at the work surface. In this manner the overheating of the fluid, and in particular over heating at the work surface, from the laser energy passing through it or for the cutting activity, may be avoided.

Moreover, a mechanical snorkel like device, or tube, which is filled with an optically transmissive fluid (gas or liquid) may be extended between or otherwise placed in the area between the laser tool and the work surface or area.

A jet of high-pressure gas may be used with the laser beam. The high-pressure gas jet may be used to clear a path, or partial path for the laser beam. The gas may be inert, or it may be air, oxygen, or other type of gas that accelerates the laser cutting.

The use of oxygen, air, or the use of very high power laser beams, e.g., greater than about 1 kW, could create and maintain a plasma bubble, a vapor bubble, or a gas bubble in the laser illumination area, which could partially or completely displace the fluid in the path of the laser beam. If such a bubble is utilized, preferably the size of the bubble should be maintained as small as possible, which will avoid, or minimize the loss of power density.

A high-pressure laser liquid jet, having a single liquid stream, may be used with the laser beam. The liquid used for the jet should be transmissive, or at least substantially transmissive, to the laser beam. In this type of jet laser beam combination the laser beam may be coaxial with the jet. This configuration, however, has the disadvantage and problem that the fluid jet does not act as a wave-guide. A further disadvantage and problem with this single jet configuration is that the jet must provide both the force to keep the drilling fluid away from the laser beam and be the medium for transmitting the beam.

A compound fluid laser jet may be used as a laser tool. The compound fluid jet has an inner core jet that is surrounded by annular outer jets. The laser beam is directed by optics into the core jet and transmitted by the core jet, which functions as a waveguide. A single annular jet can surround the core, or a plurality of nested annular jets can be employed. As such, the compound fluid jet has a core jet. This core jet is surrounded by a first annular jet. This first annular jet can also be surrounded by a second annular jet; and the second annular jet can be surrounded by a third annular jet, which can be surrounded by additional annular jets. The outer annular jets function to protect the inner core jet from the drill fluid present in the annulus between the laser cutter and the structure to be cut. The core jet and the first annular jet should be made from fluids that have different indices of refraction. Further examples of such cutters, tools, jets, compound jets and related uses are disclosed and taught in the following US patent applications: Ser. No. 13/210,581, Ser. No. 13/222,931, Ser. No. 13/211,729 and Ser. No. 61/514,391, the entire disclosures of each of which are incorporated herein by reference.

The systems and methods of the present inventions are, in part, directed to the cleaning, resurfacing, removal, and clearing away of unwanted materials, e.g., build-ups, deposits, corrosion, or substances, in, on, or around structures, e.g. the work piece, or work surface area. Such unwanted materials would include by way of example rust, corrosion, corrosion by products, degraded or old paint, degraded or old coatings, paint, coatings, waxes, hydrates, microbes, residual materials, biofilms, tars, sludges, and slimes. The present inventions enable the ability to have laser energy of sufficient power and characteristics to be transported over great lengths and delivered to remote and difficult to access locations. An example of a preferred application for the present inventions would be in field of “flow assurance,” (a broad term that has been recently used in the oil and natural gas industries to cover the assurance that hydrocarbons can be brought out of the earth and delivered to a customer, or end user) they would also find many applications and uses in other fields as illustrated by the following examples and embodiments. Moreover, the present inventions would have uses and applications beyond oil, gas, geothermal and flow assurance, and would be applicable to the, cleaning, resurfacing, removal and clearing away of unwanted materials in any location that is far removed from a laser source, or difficult to access by conventional technology as well as assembling and monitoring structures in such locations.

The parameters of the laser energy delivered to a substrate having an unwanted material should be selected to provide for the efficient removal, or degradation of the unwanted material, while minimizing any harm to the substrate. The laser delivery parameters will vary based upon, for example, such factors as: the desired duty cycle; the surface area of the substrate to be cleaned; the composition of the substrate; the thickness of the substrate; the opacity of the unwanted material; the composition of the unwanted material; the absorptivity and/or reflectivity of the unwanted material for a particular laser wavelength; the absorptivity and/or reflectivity of the wanted material for a particular laser wavelength; the geometry of the laser beam; the laser power; the removal speed (linear or area); as well as, other factors that may be relevant to a particular application. Although continuous wave and pulsed delivery lasers may be useful in addressing the issue of unwanted materials in or on structures such as for example pipelines, or in or on other substrates, pulsed laser have been shown to be particularly beneficial in some applications and situation. Without limitation to the present teachings and inventions set forth in this specification, the following US patents set forth parameters and methods for the delivery of laser energy to a substrate to remove unwanted materials from the substrate: U.S. Pat. No. 5,986,234; RE33,777, U.S. Pat. No. 4,756,765, U.S. Pat. No. 4,368,080, U.S. Pat. No. 4,063,063, U.S. Pat. No. 5,637,245, U.S. Pat. No. 5,643,472, U.S. Pat. No. 4,737,628, the entire disclosures of each of which are incorporated herein by reference.

Thus, for example, the laser tool may be a laser monitoring tool for illuminating a surface of a work piece to detect surface anomalies, cracks, corrosion, etc. In this type of laser monitoring tool, the laser beam may be scanned as a spot, or other shape, along the surface of the work area, in a pattern, or it may be directed to a surface in a continuous line that impacts some or all of the inner circumference of the inner wall of the work piece. The light reflect by and/or absorbed by the surface would then be analyzed to determine if any anomalies were present, identify their location and potentially characterize them. A laser radar type of system may be used for this application, a laser topographic system may be used for this application, as well as, other known laser scanning, measuring and analyzing techniques.

The laser tool may be a laser cutter, such as the cutters discussed herein, that is used to remove unwanted material from a surface, cut a hole through, or otherwise remove a section of materials, such as milling a window in a well casing, or weld a joint between two sections of a structure, or repair a grout line between two section of structure by for example activating a heat activated grout material. The laser tool may be a laser illumination tool that provides sufficient high power laser energy to an area of the surface to kill or remove microbes and microbial related materials such as a biofilm. This type of laser illumination tool may also be used to clear and remove other materials, such as waxes, from an interior surface of for example a tank, a pipeline or a well.

In general, when dealing with cleaning activities, and by way of example, the power of the laser energy that is directed to a surface of the workpiece should preferably be such that the foreign substance, e.g., a biofilm, wax, etc., is removed or sterilized, by heating, spalling, cutting, melting, vaporizing, ablating etc., as a result of the laser beam impinging upon the foreign substance, but the underlying structure or surface is not damaged or adversely affected by the laser beam. In determining this power, the power of the laser beam, the area of surface that the laser beam illuminates, and the time that the laser beam is illuminating that surface area are factors to be balanced.

Combinations of laser tools, e.g., a cutter, an illuminator, a measurement tool, and non-laser tools, may be utilized in a single assembly, or they may be used in separate assemblies that are used sequentially or in parallel activities.

In addition to directly affecting, e.g., cutting, cleaning, welding, etc., a work piece or sight, e.g., a tubular, borehole, etc., the high power laser systems can be used to transmit high power laser energy to a remote tool or location for conversion of this energy into electrical energy, for use in operating motors, sensors, cameras, or other devices associated with the tool. In this manner, for example and by way of illustration, a single optical fiber, or one or more fibers, preferably shielded, have the ability to provide all of the energy needed to operate the remote tool, both for activities to affect the work surface, e.g., cutting drilling etc. and for other activities, e.g., cameras, motors, etc. The optical fibers of the present invention are substantially lighter and smaller diameter than convention electrical power transmission cables; which provides a potential weight and size advantage to such high power laser tools and assemblies over conventional non-laser technologies.

Photo voltaic (PV) devices, thermoelectric or mechanical devices may be used to convert the laser energy into electrical energy. Thus, as energy is transmitted down the high power optical fiber in the form high power laser energy, i.e., high power light having a very narrow wavelength distribution it can be converted to electrical, and/or mechanical energy. A photo-electric conversion device is used for this purpose and is located within, or associated with a tool, assembly or system. Examples of such PV devices and conversion systems are disclosed and taught in U.S. patent application Ser. No. 13/347,445 and in PCT patent application PCT/US12/20789, the entire disclosure of each of which are incorporated herein by reference. A thermoelectric convertor operates by generating electrical current from a temperature gradient using a Peltier effect.

### Example 1

### Carbon Gettering Mitigation

In the use of high power laser energy an effect known as carbon gettering may occur, which results in carbon deposits being formed on optical surfaces and other areas where the high power beam is transmitted. Such carbon deposits can quickly cover optics, windows or other surfaces in a laser system or laser tool, causing hot spots and failures. Such carbon deposits are more readily formed in environments or under conditions in which there is a carbon source but little or no oxygen, such as for example doing workover, completion or drilling activities in a well, and in particular if the beam is being propagated and/or the work is being done with a nitrogen blanket or in nitrogen. The problems associated with carbon gettering are driven by fluence and typically are seen when fluences exceed about 100,000 w/cm², thus, although these problems can be see with as low as about a 1 W laser, they can become more pronounced as laser power is increased, and in particular, when laser powers of greater than 20 kW, greater than 30 kW, and greater are used. Thus, high power laser systems, and in particular at locations where the beam is being transmitted, such as at an optical slip ring, or at laser tool, such as for example a laser-mechanical drill bit, a laser cutter, a laser milling tool, or a laser pipe cutting tool, may employ an anti-carbon gettering system and methods. An anti-carbon gettering system would include for example a means to provide a source of oxygen, such as by providing gas flow having oxygen to those areas where carbon deposit formation can occur. Pure oxygen, however, is not required, and for example a flow of breathable air, i.e., about 20% oxygen, may be utilized depending upon the air flow and the amount of carbon present in the system Thus, anti-carbon gettering gas flows may be less than about 50% oxygen, less than about 30% oxygen, and less than about 20% oxygen, and for use in a sealed system, the oxygen content may be less than 1% and as low as a few ppm (parts per million). This anti-carbon gettering system can be incorporated into the laser system, such as the embodiment of FIGS. 1, 2 & 4, or it can be a separate system that is brought to the work site when needed. Depending on the integrity of the optical system, ranging from hermetic sealed system to an unsealed system the amount of oxygen required is proportional to the exposure to the carbon source, such as hydrocarbons. A hermetic sealed system will require an initial fill containing some portion of oxygen to react with any carbon left inside the system due to the assembly processes. A sealed system, depending on the operating time for the system, may also only require a pre-fill of a gas with oxygen content. An unsealed system however will require a continuous purge or flow of a gas with some oxygen content. For example, in a sealed system the oxygen content may need to be only a few ppm, in a flowing gas system the oxygen content many only need to be a percent or so, depending on the application, the components of the laser system, and the operating conditions and environments for the laser system. Generally, the gettering process arises from hydrocarbon cracking present in the high power laser beam. Thus, if the beam path is kept relatively clean, e.g., free from hydrocarbons, then only trace amounts of hydrocarbon and cracked hydrocarbon will be present, requiring only an impurity level, e.g., a trace amount, or very low ppm, of oxygen to remove the deposits. The mechanism for preventing the gettering depositions is the oxidation of the carbon, e.g., converting the carbon into CO₂ which cannot be cracked again by the laser beam. The CO₂ will not deposit on or otherwise adversely effect the optics and components of the system.

### Example 2

### Tubular Assembly with Stored High Power Fiber Helix

Jointed drill pipe and jointed tubulars are used in many drilling applications. Thus, this example provides an embodiment of a device for use with or as a part of a high power laser drilling system, and in particular a high power laser drilling workover and completion system for using high power laser tools, such as laser-mechanical drill bits, with jointed tubulars. A tubular assembly contains a high power optical fiber wound inside of the tubular, preferably in a helix. The outer diameter of this tubular-fiber assembly would be no greater than the largest outer diameter of any component of the drill string, tools, or bottom hole assembly that the tubular-fiber assembly was intended to be used with. The high power optical fibers of the present invention can be very thin, generally several hundreds of a micron to a few thousands of microns. Thus, a substantial length of fiber may be helixed inside of a single piece tubular, having the length of a standard piece of drill pipe, which is about from 31 ft to about 46 ft. Moreover, many drilling rigs can handle three or four connected pieces of drill pipe, e.g. a triple or quad, and thus can handle pipe lengths of over 120 ft. Accordingly, tubular-fiber assemblies are provided with lengths of about 30 ft or greater, of about 60 ft or greater, about 90 ft or greater, of about 100 ft or greater and of about 120 ft or greater. The length of the tubular may be as long as is permitted by the particular derrick and drilling assembly, e.g., distance of travel from rotary table, or drill floor up into the derrick, for the top drive, or other tubular handling equipment.

A single tubular-fiber assembly can be placed in the drill string, at or near the bottom of the drill string, for example just above the bottom hole assembly (“BHA”), or may even be include in or as a part of the BHA. Further, one or more tubular-fiber assemblies may be placed, e.g., staggered, along the length of a very long drill string, such as would be encountered when dealing with bore holes having depths of greater than 10,000 ft, greater than 20,000 ft, greater than 30,000 ft and greater.

One end of the fiber in the tubular-fiber assembly many be attached to a connector, for a “plug-and-play” type high power laser system, or the fiber may be directly attached to a tool when the tool is attached to the tubular-fiber assembly. The other end of the fiber may have a connector, or be connected to, for example the end of another fiber in a tubular-fiber assembly, a high power laser, or in the case where the drill string will be rotated, such as with a BHA and a laser-mechanical bit, an optical slip ring may be associated with the top drive or other source of rotation for the drill pipe, or an optical slip ring assembly may be contained within or near to the tubular-fiber assembly. In this way either the entire length of the fiber within the drill string can rotate with the string, or the fiber within the drill string does not rotate above the location of the optical slip ring device and rotates with the drill string below the slip ring.

In operation as the drill string, tubular-fiber assembly and tool are tripped-in the fiber can be pulled from the interior of the drill string and run through the next section of drill pipe, or, and preferably, once the intend depth for the string has been reached a fishing tool can be sent down attached to the fiber end, or connector, and pull the fiber to the rig floor where it will be optically connected to the high power laser. (Tripping-in is the process of running or advancing a drill sting into a borehole to the depth where drilling or other activates are to occur. Tripping-out is the process of removing the drill string form the borehole. To trip-in or -out, pieces of drill string are added or removed from a drill string to lengthen or shorten the string is as it is advanced into or pulled out of a borehole.) In tripping-out, the fiber can be automatically disconnected from the tubular-fiber assembly and recovered first, or it can be re-helixed by fixing a section of the fiber and using the turning of the drill string and/or a re-helixing assembly, to helix the fiber in the tubular-fiber assembly.

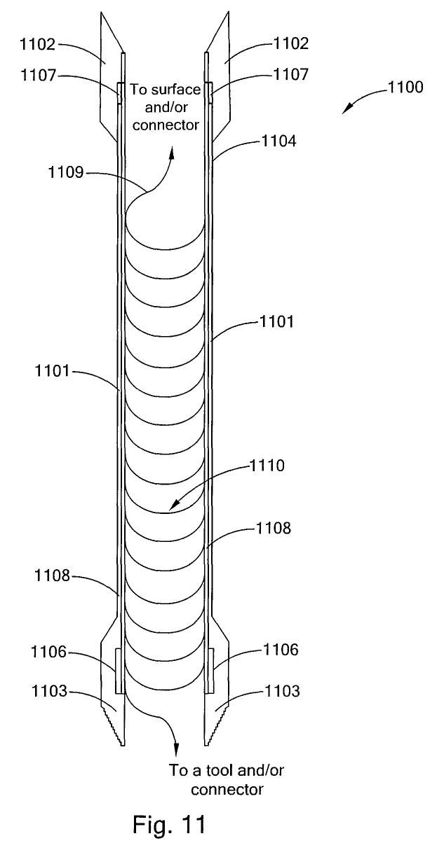

Turning to FIG. 11, there is shown a cross-sectional view of an embodiment of a tubular-fiber assembly. Thus there is provided a tubular-fiber assembly 1100 having a tubular 1104. The tubular has an outer wall 1101 that has a first joint section 1102 and a second joint section 1103 at its ends. Associated with the joint sections are bearing assemblies 1106, 1107 that may also rotationally support a rotating sleeve 1108. The high power optical fiber 1109 is contained within this sleeve in a helical configuration 1110.

### Example 3

### Enhanced High Power Laser Assisted Logging, Measuring and Monitoring Systems

The use of high power laser energy in drilling, cutting, machining and milling related activities has the potential to perform such activities with greatly reduced noise and/or vibration levels, when compared to conventional non-laser technologies used to accomplish these activities. This ability to greatly reduce noise and vibration provides, among many benefits, the ability to perform real-time and/or simultaneous monitoring, measuring, data collection and other observations of the activity, the conditions for the activity, and the surrounding environment and area of the work site, with out interference from the noise and vibration that would accompany conventional non-laser technology. In addition to greatly improving the ability to monitor, measure, data collect and observe, the reduction in noise and vibration may further provide the ability for real-time and/or simultaneous monitoring, measuring, data collection and other observations that were previously thought to be impossible.

The reduction in noise and vibration has the further advantage of permitting activity in areas or situation where such noise could prove to be against zoning ordinances, rules or environmental considerations.

One such utilization for this benefit of noise and vibration reduction that the present high power laser systems provide is in the area of logging while drill (“LWD”) and measuring while drilling (MWD) and combination thereof (LWD/MWD). When using laser-mechanical drilling processes, such as disclosed and taught in the following US patent applications and patent application Publications: US 2010/0044106; US 2010/0044103; Ser. No. 61/446,041; Ser. No. 61/446,042; co-filed patent application having attorney docket no. 13938/78 (Foro s3a-1) filed contemporaneously herewith; co-filed patent application having attorney docket no. 13938/81 (Foro s6a) filed contemporaneously herewith, the entire disclosures of each of which are incorporated herein by reference, reductions in the weight-on-bit (WOB), in the order of many magnitudes, needed to advance a borehole through hard and ultra-hard rock have been observed. This reduction in WOB can result in greatly reduced noise and vibration levels. For example and preferably, this reduction in WOB permits the use of a motor, or other means to supply rotational movement to the bit, such as an electric motor, that still further reduces vibrations. For example, this system and method provides the ability for greatly enhancing logging, measuring and monitoring systems, by advancing a borehole with a laser bottom hole assembly in association with a logging, measuring and monitoring system. The borehole is advanced by utilizing at least about 50 kW of laser power and utilizing less than about 2,000 lbs, less than about 1,000 lbs, and more preferably less than about 500 lbs WOB. In this manner the noise and vibrations from advancing the bore hole are at a low level at least two times lower, at least about 5 times lower, and at least about 10 times lower, than a level that interferes with the logging measuring, and monitoring systems, which level is typically set based upon, configured in view of, conventional mechanical drilling technologies, vibrations, noise, etc. Thus, providing for enhanced and more accurate MWD, LWD and MDW/LWD.

Additionally, the high power laser may be used in LWD providing the ability to measure the formation (rock and fluid) with the laser energy to determine petrophysical, geological, and fluid identification in the pores.

### Example 4

### Casing While Drilling

The use of high power laser energy and/or high power laser energy in conjunction with mechanical removal of material, including laser-affected material for the borehole, provides the ability to perform laser-assisted case while drilling and laser-assisted directional casing while drilling. The potential for reduced vibrations, reduced WOB, and smoother borehole surfaces (without the need for reaming) provide additional benefits, among others, for this high power down hole laser application.

Thus, for example, a down hole assembly having a down hole motor, e.g., electric motor, turbine, or positive displace motor, a MWD system, a rotary steerable system and a laser-mechanical bit that is optically connected to a high power laser on the surface may be employed. This down hole assembly would further have a casing shoe, a means to device to attach the casing to the motor and an under reamer to conform the hole side to the casing being used. The under-reamer may be a laser-mechanical under-reamer, or may not be needed if the laser beam profile at the bit is such that the laser-mechanical bit provides a sufficient borehole diameter and smoothness.

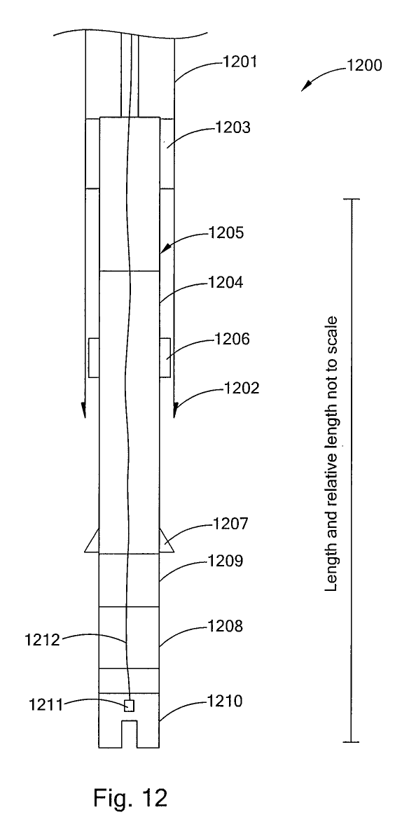

A example of an such an embodiment as deployed is shown in FIG. 12. Thus, there is provided a laser directional drilling while casing assembly 1200. The assembly 1200 associated with a casing string 1201, having a casing shoe 1202. A casing motor assembly 1203 connects, fixes the down hole power section 1204 to the casing 1201. The down hole power section has a motor 1205 a stabilized assembly 1206, a laser-reamer (under reamer in the embodiment shown in the figure) a RSS 1208, a MWD 1209, a laser-mechanical bit 1210, an optics package 1211, and a high power optical fiber cable 1212. In operation the embodiment of FIG. 12 the casing would be rotated at an RPM of about 10 to 30, and the mud motor would be rotated at an RPM of about 100 to 600. Preferably, about greater than 50 kW and more preferably about greater than 80 kW of laser power would be available to the bottom of the borehole. Greater and lesser laser powers are also contemplated. The WOB may be preferably below 1000 lbs and more preferably below 500 lbs.

### Example 5

### Tool to Dislodge a Packer

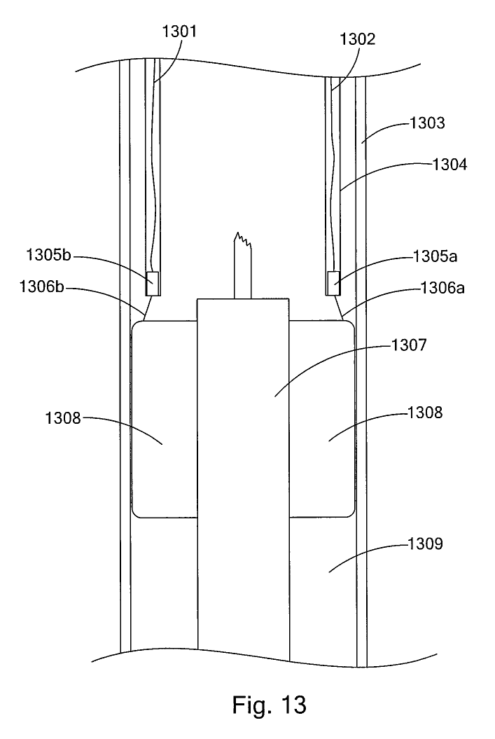

Packer and other such devices may become lodge in a borehole against the casing or an uncased borehole surface. It may take a considerable amount of time, effort and money to dislodge a packer that has become stuck. There is provided a high power laser tool, has one or more high power laser cutters that is lowered to the stuck packer. The high power laser tool then cuts the outer area of the packer, e.g., the area adjacent to the casing, or other sections of the packer, weakening the packer and/or grip that the packer has on casing freeing the packer or enabling the packer to be freed with substantially less force than would be required with out the packer having been cut by the laser. An embodiment of a laser tool to dislodge a jammed packer is provided in FIG. 13. The laser cutter, which preferably cold be along the lines of a laser kerfing assembly to direct the laser energy along the outer edges, e.g., the gauge area of the borehole. The laser cutter may further be a series of laser cutters that are rotate by the tool, or by a down hole motor.

### Example 6

### Ultra Smooth Boreholes

The laser and laser-mechanical drilling process provide boreholes having sidewalls that are very smooth. Borehole sidewall smoothness, for example in hard rock, such as, granite and basalt may have slight, to little, to no visually observable rugosity. Further the sidewall smoothness may have a surface roughness of less 0.05″. These wall properties are obtainable without reaming. Thus, there is provided a method to obtain smooth borehole surfaces without the need of any subsequent processing of the borehole, by using a high power laser mechanical drilling system.

### Example 7

### Hydrate Removal

Hydrates form at low-temperature, high-pressure in the presence hydrocarbons and water. Hydrate formation can plug flow lines, equipment and other structures and devices used in deepwater offshore hydrocarbon exploration and production. The kinetics of hydrate formation is dependent upon, among other things the nature of the crude oil being produced. Thus, the rate of hydrate formation may be very different from well to well, or as other factors change on a single well. To address, mitigate and manage hydrate related problems there is provided a method of positioning a high power laser tool, for example a laser cutter or a laser illuminator in the areas where hydrate formation is likely, where flow assurance is critical, where hydrate formation has been detected or observed and combinations thereof. The laser tool is connected to a high power laser, preferably on the surface, by way of a high power laser cable. The high power laser energy is then delivered to abate the hydrate formation, for example by heating the structure, by maintaining the structure at a certain level, preferably above a temperature at which hydrate formation can occur, by directly heating, cutting or ablating the hydrate, and combinations of the foregoing.

A preferred wavelength for treating and managing hydrate formation would be about 1.5 μm or greater, more preferably from about 1.5 μm to about 2 μm, which is a wavelength range, as taught in the co-pending high power laser transmission specification, that can be transmitted down the fiber over great lengths without substantial power losses, and is also a wavelength range that is preferentially absorbed by the hydrate.

### Example 8

### High Power Laser Intelligent Completions & Sensors

In this embodiment of a high power laser system, there is provided the use of high power laser energy and the use of high power laser optical cables for intelligent completion and sensor systems for wells, e.g., smart wells, including gas, oil and geothermal wells. These systems use a high power optical cable and high power lasers, to transmit and provide down hole power (either optical and/or opt-electrical), data, control information, and combinations thereof, from the surface to system's components, such as for example optical sensors. As addressed in the specification above, when a single fiber is being used for both power and data transmission the wavelengths, pulse rates, plus widths, and other parameters of the laser beams need to be addressed to maximize fiber performance, avoid interferences and maintain the suppression of non-linear effects. In this manner the size and complexity of conventional, i.e., non-high power laser cables, used to power and operate such systems can be minimized and/or avoided. Such high power laser smart well systems may have or include equipment for down hole flow control, hydrate formation control, the management of multi-lateral completions, controlling commingled production, controlling down hole water separation, controlling down hole gas separation, equipment for down hole gas re-injection, and pressure control, among other things.

Thus, a high power laser smart well system may preferably provide one, several or all of these features: automatic surface interaction with sub-surface equipment; continuous monitoring of sub-surface conditions; automatic flow control; real-time control loops; and extensive down hole communications and data transmission. These and potentially other features are provided through the utilization of the high power optical fibers provided in this specification.

These high power laser smart wells also provide the benefit of monitoring, evaluating and characterizing the formation, preferably in real-time and continuously, for such characteristics as fluid-gas contact zones, gas-water coning, saturation, structure, pressure and temperature, to name a few. In this manner these systems provide the ability to quickly and consistently optimize reservoir drainage and production. Although the benefits of such high power laser systems may be realized to a greater or lesser extent in many, if not most, wells, these systems may be particularly beneficial if utilized in marginal wells, highly deviated wells, horizontal wells, deepwater wells and high volume wells.

### Example 9

### Artificial Lift Pumps

In this embodiment of a high power laser system, there is provided the use of high power laser energy and the use of high power laser optical cables for powering, controlling and/or monitoring artificial lift systems and, in particular, artificial lift pumps, such as, for example, progressive cavity pumps, electric submersible pumps, and hydraulic pumps.

### Example 10

### Subsea Completions

In this embodiment of a high power laser system, there is provided the use of high power laser energy and the use of high power laser optical cables for powering, controlling and/or monitoring equipment and components that make up a subsea production field. Such equipment and components would include, for example, subsea trees, controls, manifolds, and tie-ins. There is further provided a high power optical fiber network, which forms a part of the subsea field.

### Example 11

### Seismic Systems

In this embodiment of a high power laser system, there is provided the use of high power laser energy and the use of high power laser optical cables for powering, controlling and/or monitoring a seismic monitoring system, and in particular the sensor used in such system and the data and information obtained from those sensors.

### Example 12

### Down Hole Heating for Heavy Oil

In this embodiment of a high power laser system, there is provided the use of high power laser energy and the use of high power laser optical cables for powering, controlling and/or monitoring equipment and components that make up a heating system for the production and recovery of heavy oil.

### Example 13

### Tractors

In this embodiment of a high power laser system, there is provided the use of high power laser energy and the use of high power laser optical cables for powering, controlling and/or monitoring down hole tractors and similar types of down hole equipment. Further the down hole tractor may be equipped with a laser cutting, laser illumination, laser drilling and/or laser-mechanical drilling tool.

### Example 14

### Flow Assurance

Flow assurance is the method and related practices and procedures to ensure an uninterrupted flow of hydrocarbons from the well, to a storage facility and to the end recipient. In this embodiment of a high power laser system, there is provided the use of high power laser energy, the use of high power laser optical cables for powering, controlling and/or monitoring equipment and components, and/or the use of remote high power laser tools, to provide a high power laser flow assurance system.

### Example 15

### Paint Removal

In this embodiment of a high power laser system, there is provided the use of high power laser energy, the use of high power laser optical cables for powering, controlling and/or monitoring equipment and components, and/or the use of remote high power laser tools, to provide a system for removing paint. This system would provide the added advantage that it would eliminate the waste, noise and other environmental issues, with conventional abrasive, mechanical or chemical paint removal techniques. This system would also provide the ability to remove paint, or other coatings, from areas that are remote, distant or otherwise difficult to access.

### Example 16

### Corrosion/Biologics Control

In this embodiment of a high power laser system, there is provided the use of high power laser energy, the use of high power laser optical cables for powering, controlling and/or monitoring equipment and components, and/or the use of remote high power laser tools, to provide a system for removing or controlling, corroded material, corrosion, or mitigating unwanted biologics that coat, cover or adversely affect a structure or surface. This system would provide the added advantage that it would eliminate the waste, noise and other environmental issues, with conventional abrasive, mechanical or chemical paint removal techniques.

### Example 17

### Other Methods

The high power systems may be used to provide controlled perforations, including perforations having predetermined shape for the oil, gas and geothermal stimulation and production. Additionally, such controlled cuts or perforations may be used for stimulation and/or recovery of hydrocarbons from coal bed methane and oil shale formations.

From the foregoing examples, there are contemplated several illustrative embodiments. For example, there is provided a method of providing an high power optical connection between a high power laser source and a high power laser tool located at a remote location, the method including: advancing a tubular-fiber assembly associated with a laser tool to a predetermined location removed from a source of high power laser beam, the tubular-fiber assembly containing a high power optical fiber having a proximal end and a distal end in optical association with a high power laser tool; withdrawing the proximal end of the optical fiber from the tubular-fiber assembly and there by withdrawing at least a portion of the optical fiber from the tubular-fiber assembly, while maintaining the distal end in optical association with the high power laser tool; and, optically associating the proximal end of the cable with the source of the high power laser beam; whereby a high power laser beam is transmitted from the laser source to the high power laser tool. Yet further, there are provided methods that may also include: where the tubular-fiber assembly has a length of about 30 feet to about 120 feet, and comprises at least about 1,000 feet of high power optical fiber; and where the remote location is within a borehole and the remote location is at least about 5,000 feet from the high power laser source. Still further there is provided a method of enhancing logging, measuring and monitoring system, the method including advancing a borehole with a laser bottom hole assembly in association with a logging, measuring and monitoring system, and utilizing at least about 50 kW of laser power and utilizing less than about 2,000 lbs WOB, whereby noise and vibrations from advancing the bore hole are at a low level at least two times lower than a level that interferes with the logging measuring, and monitoring systems. Yet further, there are provided methods that may also include: where the logging, measuring and monitoring system is a LWD system; where the logging, measuring and monitoring system is a MWD system; and where the logging, measuring and monitoring system is a LWD/MWD system. Moreover, there is provided a method of casing while drilling including lowering a laser bottom hole assembly having a means for providing rotation, a laser under reamer, a laser-mechanical bit and an optics package to the bottom of a borehole, advancing the bore hole by rotating the means to rotate and delivering a high power laser beam to surfaces of the borehole from the laser under reamer and laser-mechanical bit while being rotated by the rotating means. Furthermore, there is provided a method of dislodging a stuck packer or tool from a borehole including positioning a high power laser cutting tool adjacent an obstruction in a borehole, the high power laser tool in optical association with a source of high power laser energy, directing a high power laser beam, from the high power laser t to cut the obstruction thereby permitting its removal. Still further, there is provided a method of providing electrical power to an intelligent completion and sensor system of a well including: providing a photovoltaic device in a location in the well, electrically associating the photovoltaic device with the system, optically associating the photovoltaic device with a source for a high power laser beam, whereby high power laser energy is provided to the photovoltaic to provide electrical energy to the system. Additionally, there is provided a method of providing electrical power to an artificial lift pump system in a well including: providing a photovoltaic device in a location in the well, electrically associating the photovoltaic device with the system, optically associating the photovoltaic device with a source for a high power laser beam, whereby high power laser energy is provided to the photovoltaic to provide electrical energy to the system. Yet still further, there is provided a method of providing electrical power to a subsea completion system for a well including: providing a photovoltaic device in a location in the well, electrically associating the photovoltaic device with the system, optically associating the photovoltaic device with a source for a high power laser beam, whereby high power laser energy is provided to the photovoltaic to provide electrical energy to the system. Moreover, there is provided a method of providing electrical power to a seismic sensing system including: providing a photovoltaic device in a location associated with the formation to be monitored by the system, electrically associating the photovoltaic device with the system, optically associating the photovoltaic device with a source for a high power laser beam, whereby high power laser energy is provided to the photovoltaic to provide electrical energy to the system.

The foregoing examples are illustrative only and are not meant to, and do not limit the many and varied applications that are available for the high power laser systems of the present inventions. These systems provide the ability to deliver many kW of power, e.g, greater than 10 kW, greater than 50 kW, greater than 100 kW and, over great distances, e.g., greater than 1 km, greater than 5 km, greater than 10 kM. through light weight, high power optical cables. Further, these systems provide the capability to transmit and receive data and control information over the same lightweight optical cable. Thus, these systems will find application in, for example, uses where high power energy is needed in a remote location for the processing of material, control and/or powering of equipment and/or the transmission and retrieval of information and data.

The inventions may be embodied in other forms than those specifically disclosed herein without departing from their spirit or essential characteristics. The described embodiments are to be considered in all respects only as illustrative and not restrictive.

What is claimed:

1. A method of protecting optics and components of a high power laser system while performing laser operations at a remote location from damage from carbon gettering migration, the method comprising:
a. delivering a high power laser beam to a remote location by means of a high power laser system comprising a high power laser having at least about 20 kW of power, an optical transition device, an of optical connector, an optical cable and a high power laser tool comprising an optical package;
b. propagating a laser beam having at least about 20 kW along a beam path, wherein the beam path is optically associated with the optical transition device, the optical connector, the optical cable and the high power laser tool and the optical package, whereby the laser beam is delivered to the remote location; and,
c. providing a means for preventing carbon gettering on a component of the high power laser system;
d. whereby, carbon deposits are prevented from covering the component of the high power laser system.

2. The method of claim 1, wherein the means for preventing comprises providing a gas flow having less than about 20% oxygen.

3. The method of claim 2, wherein the means for preventing is provided to a plurality of components of the high power laser system.

4. The method of claim 4, wherein the plurality of components comprises: the optical transition device, the optical connector, an end of the optical cable, and the optical package of the high power laser tool.

5. The method of claim 1, wherein the laser beam has a power of at least about 50 kW.

6. The method of claim 1, wherein the laser beam ahs a power of at least about 80 kW.

7. The method of claim 2, wherein the laser beam has a power of at least about 50 kW.

8. The method of claim 3, wherein the laser beam has a power of at least about 50 kW.

9. The method of claim 4, wherein the laser beam has a power of at least about 50 kW.

10. The method of claim 2, wherein the laser beam has a power of at least about 80 kW.

11. A method of protecting optics and components of a high power laser system while performing laser operations at a remote location from damage from carbon gettering migration, the method comprising:
a. delivering a high power laser beam to a remote location by means of a high power laser system comprising a high power laser having at least about 30 kW of power, an of optical connector, an optical cable having a distal and a proximal end, and a high power laser tool;
b. propagating a laser beam having at least about 20 kW along a beam path, wherein the beam path is optically associated with the optical connector, the optical cable, the distal end of the optical cable, the proximal end of the optical cable and the high power laser tool, and wherein a fluence along the beam path is at least about 100,000 w/cm², and whereby the laser beam is delivered to the remote location; and,
c. providing a means for preventing carbon gettering on a component of the high power laser system;
d. whereby, carbon deposits are prevented from covering the component of the high power laser system.

12. The method of claim 11, wherein the means for preventing comprises providing a gas flow comprising air.

13. The method of claim 12, wherein the means for preventing is provided to a plurality of components of the high power laser system.

14. The method of claim 13, wherein the plurality of components comprises: the optical connector, the distal end of the optical cable, the proximal end of the optical cable and the high power laser tool.

15. The method of claim 11, wherein the means for preventing is provided by sealing an optical assembly with an amount of oxygen present.

16. The method of claim 11, wherein the means for preventing is provided by purging an optical assembly with a gas comprising oxygen and the sealing the optical assembly.

17. The method of claim 15, wherein the amount of oxygen present is less than about 1%.
